(19) United States
(12) Patent Application Publication
(10) Pub. No.: US 2024/0208799 A1
(43) Pub. Date: Jun. 27, 2024

(54) CUSHION ASSEMBLY

(71) Applicant: Lear Corporation, Southfield, MI (US)

(72) Inventors: David HALE, Southfield, MI (US); Wu Pan ZAGORSKI, Clawson, MI (US); Samuel BLAIR, Troy, MI (US); Joshua HALLOCK, Warren, MI (US)

(21) Appl. No.: 18/515,509

(22) Filed: Nov. 21, 2023

Related U.S. Application Data
(63) Continuation of application No. 18/087,857, filed on Dec. 23, 2022.

(51) Int. Cl. B68G 7/05

(52) U.S. Cl. CPC B68G 7/05; B60N 2/5866

(57) ABSTRACT

An assembly is provided with a unitary mesh of expanded thermoplastic resin strands with a cavity formed therein. A trim component or a support member is oriented at least partially within the cavity. A weld is formed at least partially along the mesh adjacent to the cavity to retain the trim component or the support member within the cavity.

### CROSS-REFERENCE TO RELATED APPLICATIONS

This application is a continuation of U.S. application Ser. No. 18/087,857 filed Dec. 23, 2022, now U.S. Pat. No. ______, the disclosure of which is hereby incorporated in its entirety by reference herein.

### TECHNICAL FIELD

Various embodiments relate to cushions formed from a unitary mesh of expanded thermoplastic resin strands.

### BRIEF DESCRIPTION OF THE DRAWINGS

FIG. 1 is a front perspective view of a seat assembly according to an embodiment;

FIG. 2 is a top perspective view of a cushion assembly of the seat assembly of FIG. 1, according to an embodiment;

FIG. 3 is a side perspective view of the cushion assembly of FIG. 2;

FIG. 4 is a front perspective view of the cushion assembly of FIG. 2;

FIG. 5 is a front perspective view of a cushion assembly of the seat assembly of FIG. 1, according to an embodiment;

FIG. 6 is a top view of the cushion assembly of FIG. 5;

FIG. 7 is a side elevation view of the cushion assembly of FIG. 5;

FIG. 8 is a front view of the cushion assembly of FIG. 5;

FIG. 9 is perspective view of a manufacturing method according to an embodiment;

FIG. 10 is another perspective view of the manufacturing method of FIG. 9;

FIG. 11 is another perspective view of the manufacturing method of FIG. 9; and

FIG. 12 is another perspective view of the manufacturing method of FIG. 9.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

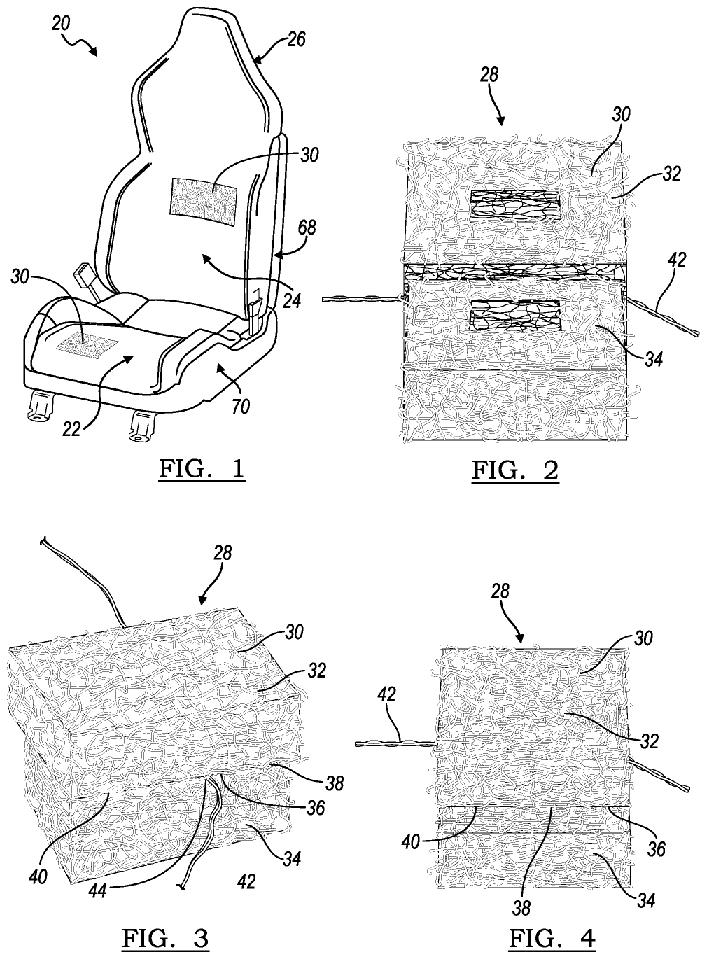

FIG. 1 illustrates a seat assembly 20 as a vehicle seat assembly 20 according to an embodiment. Although the vehicle seat assembly 20 is illustrated and described, any seat assembly 20 may be employed. The seat assembly 20 may be utilized in a land vehicle, aircraft, watercraft, or the like. The seat assembly 20 may also be utilized as an office chair, comfort chair, or the like.

The depicted seat assembly 20 includes a seat bottom cushion 22 to support a pelvis and thighs of a seated occupant. The seat assembly 20 also includes a seat back cushion 24 to support a back and shoulders of the seated occupant. A trim cover 26 is provided over the seat cushions 22, 24 to conceal the cushions 22, 24 and provide a uniform and smooth contact surface for the occupant.

Referring now to FIGS. 2-4, a cushion assembly 28 is illustrated, disassembled from the seat assembly 20. The cushion assembly 28 is formed from a plurality of strands 30 of an extruded, expanded thermoplastic resin as disclosed in Geisler et al., U.S. provisional patent application 63/357,163 filed on Jun. 30, 2022, by Lear Corporation, the disclosure of which is incorporated in its entirety by reference herein.

The cushion assembly 28 is provided by two mesh portions 32, 34 each formed from a unitary, non-foam mesh of thermoplastic resin strands 30. The mesh portions 32, 34 are joined together, at least partially along mating surfaces 36, 38 between the mesh portions 32, 34. A weld 40 is formed at least partially along the mating surfaces 36, 38 of the mesh portions 32, 34. The two mesh portions 32, 34 may be separately formed mesh layers 32, 34, or may be integrally formed as two separate regions 32, 34, that are folded to overlap to be welded.

The mesh portions 32, 34 may each include a skin 36, 38 formed as the mating surfaces 36, 38 of the mesh portions 32, 34 to increase a contact area for the weld 40. The skins 36, 38 may be formed by a denser concentration of the strands 30 at the mating surfaces 36, 38 to form the skins 36, 38 from a denser surface of strands 30. The weld 40 extends along the mesh portions 32, 34 as a seam therebetween, thereby enclosing the mesh portions 32, 34 and/or adjoining the separate segments 32, 34.

The cushion assembly 28 also includes a trim component, such as a tab, or a support, such as a suspension wire 42, enclosed within the cushion assembly 28. The suspension wire 42 is oriented between the mating surfaces 36, 38 of the mesh portions 32, 34. The weld 40 is formed around the suspension wire 42. Due to the flexibility of the mesh portions 32, 34, the mesh portions 32, 34 are compressed around the suspension wire 42, thereby defining a cavity 44 between the mating surfaces 36, 38 to retain the suspension wire 42.

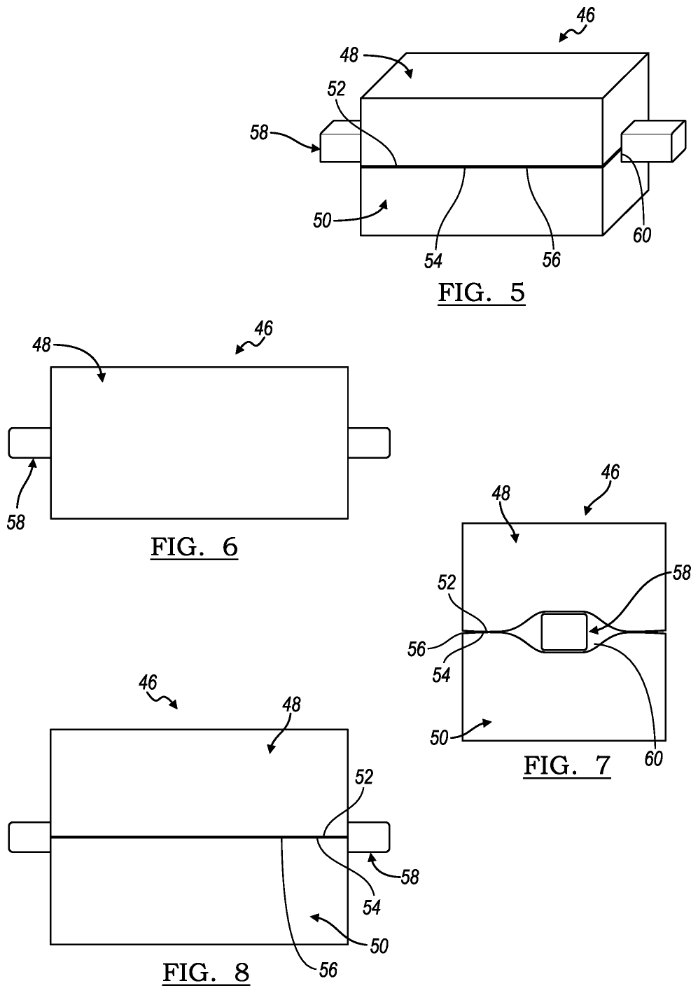

FIGS. 5-8 illustrate a cushion assembly 46 for the seat assembly 20. Similar to the prior embodiment, the cushion assembly 46 is formed from a plurality of strands 30 of an extruded, expanded thermoplastic resin as disclosed in the Geisler et al., U.S. provisional patent application 63/357,163 filed on Jun. 30, 2022, by Lear Corporation.

The cushion assembly 46 is provided by two mesh portions 48, 50 each formed from a unitary, non-foam mesh of thermoplastic resin strands 30. The mesh portions 48, 50 are joined together, at least partially along mating surfaces 52, 54 between the mesh portions 48, 50. A weld 56 is formed at least partially along the mating surfaces 52, 54 of the mesh portions 48, 50. The two mesh portions 48, 50 may be separately formed mesh layers 48, 50, or may be integrally formed as two separate regions 48, 50, that are folded to overlap to be welded.

The mesh portions 48, 50 may each include a skin 52, 54 formed as the mating surfaces 52, 54 of the mesh portions 48, 50 to increase a contact area for the weld 56. The skins 52, 54 may be formed by a denser concentration of the strands 30 at the mating surfaces 52, 54 to form the skins 52, 54 from a denser surface of the strands 30. The weld 56 extends along the mesh portions 48, 50 as a seam therebetween, thereby enclosing the mesh portions 48, 50 and/or adjoining the separate segments 48, 50.

The cushion assembly 46 also includes a trim component, such as a tab or clip, or a support 58, such as a suspension wire, embedded, and enclosed at least partially within the cushion assembly 46. In the depicted embodiment, the support 58 extends out of both longitudinal ends of the cushion assembly 46. However, the support 58 may be a tab extending from one lateral end of the cushion assembly 46.

The support 58 is oriented between the mating surfaces 52, 54 of the mesh portions 48, 50. The weld 56 is formed along both lateral sides of the support 58. Due to the flexibility of the mesh portions 48, 50, the mesh portions 48, 50 are compressed around the support 58, thereby defining a cavity 60 between the mating surfaces 52, 54 to retain the support 58.

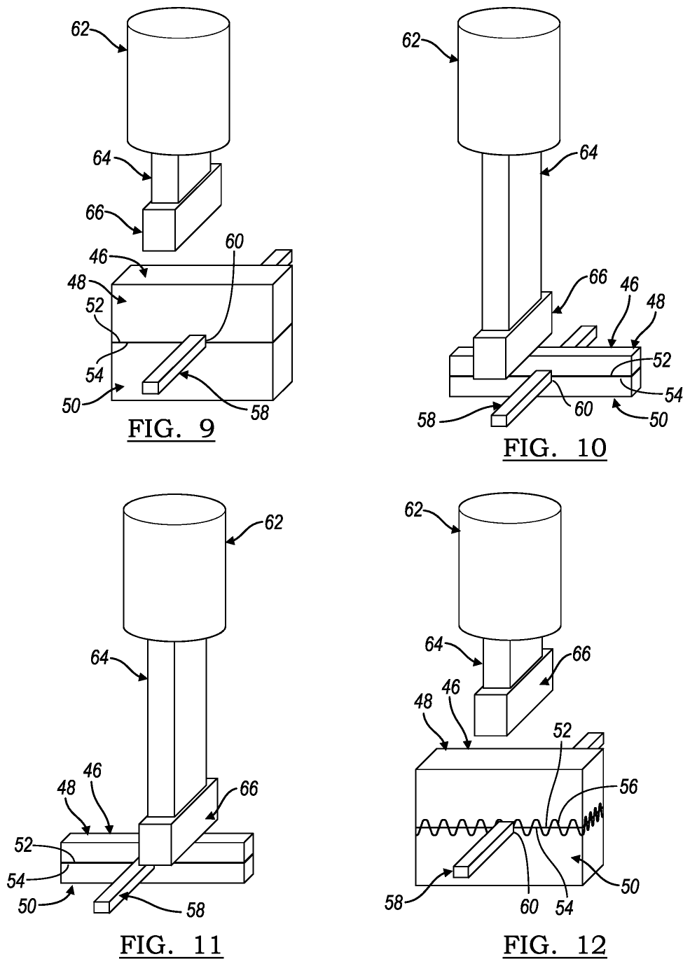

FIG. 9 illustrates the mesh portions 48, 50 stacked upon each other with the support 58 therebetween. The mesh portions 48, 50 are presented beneath a welder 62. The welder 62 may be automated or operated manually. According to one embodiment, the welder 62 is an ultrasonic welder 62. Any welder 62 may be employed, such as a heated welder or a friction stir welder. The welder 62 includes a welder arm 64 with a weld tip 66 at a distal end of the welder arm 64.

In FIG. 10, the welder arm 64 extends the weld tip 66 into contact with the mesh portion 48 on one lateral side of the support 58, thereby compressing the mesh portions 48, 50 to enhance contact between the mesh portions 48, 50. In FIG. 10, the weld tip 66 is also vibrated ultrasonically under the pressure of the welder arm 64 to create friction between the mesh portions 48, 50 to melt the mesh portions 48, 50 at the mating surfaces 52, 54. The melted mating surfaces 52, 54 of the mesh portions 48, 50 cool to solidify and form the weld 56.

Referring back to FIG. 9, the weld arm 64 is retracted, which permits the mesh portions 48, 50 to expand. Next, FIG. 11 illustrates that the welder 62 is oriented on the other lateral side of the support 58. The cushion assembly 46 may be provided on automation equipment to present the orientation. Alternatively, the welder 62 may be supported upon automation for actuation to the position of FIG. 11.

In FIG. 11, the welder arm 64 extends the weld tip 66 into contact with the mesh portion 48 on the other lateral side of the support 58, thereby compressing the mesh portions 48, 50 to enhance contact between the mesh portions 48, 50. In FIG. 11, the weld tip 66 is also vibrated ultrasonically under the pressure of the welder arm 64 to create friction between the mesh portions 48, 50 to melt the mesh portions 48, 50 at the mating surfaces 52, 54. The melted mating surfaces 52, 54 of the mesh portions 48, 50 cool to solidify and form the weld 56.

In FIG. 12, the weld arm 64 is retracted to permit the mesh portions 48, 50 to expand as the unitary welded cushion assembly 46. The weld 56 includes a consistent depth, such as a quantity of strands 30 beyond the mating surfaces 52, 54. The quantity of strands 30 may be up to three strands 30, for example. The consistent depth of the weld 56 is more consistent and repeatable than an adhesive, which often drips beyond the mating surfaces, and creates a denser and inconsistent bond beyond the lower mating surface. By omitting adhesives, the cushion assembly 46 is formed from one consistent material, thereby simplifying recyclability. Additionally, the weld 56 provides a flexibility that is less rigid in comparison to a comparable adhesive bond. By welding mesh portions 48, 50 specialized die heads for forming the mesh portions 48, 50 may be avoided or simplified.

The welded cushion assembly 46 provides a lightweight, sustainable comfort solution for seat assemblies 20, thereby reducing vehicle weight, while maintaining occupant support, to reduce cost and enhance fuel efficiency. The strands 30 of the mesh portions 48, 50 provide a reduced surface area for bonding. However, compressing the mesh portions 48, 50 enhances the density and area of the mating surfaces 52, 54 to create the weld 56, which is stronger than adhesives in applicable testing, such as shear resistance. Although two mesh portions 48, 50 are illustrated welded together, any number of mesh portions 48, 50 and any number of welds 56 for any number of supports 58 may be employed to fabricate various cushion assemblies 46. Additionally, supports 58 or trim components 58 of various materials can be utilized in combination with the cushion assembly 46. For example, the support 58 may be a rigid plastic tab or a layered material.

Various parameters of the welding process can be varied for various specifications or applications. For example, the power, voltage, and current of the welder 62 can be adjusted to adjust the performance of the weld 56. Likewise, adjustment of proximity of a point of contact of the weld tip 66 and the mesh portion 48, and a pressure applied to the mesh portions 48, 50 by extension of the weld arm 64 can also vary the weld 56 performance. The time of the weld 56 can also be varied for varying the performance. At the welder tip 66, a frequency of the tip 66 can be varied for a varied weld performance. Additionally, a shape of the welder tip 66 can be adjusted to adjust performance to result in a surface weld, a point weld, or the like.

Various configurations of mating surfaces 52, 54 may also be employed to achieve different mating configurations. For example, both mating surfaces 52, 54 may include a skin layer. Alternatively, one of the mating surfaces 52 may include a skin layer, while the other mating surface 54 includes a less dense surface area of strands 30. In another embodiment, both mating surfaces 52, 54 do not include skin layers. Additionally, the weld 56 can be varied by varying the material of the mesh portions 48, 50, adjusting an area of the mating surfaces 52, 54, or changing a quantity of welds between the mesh portions 48, 50. Various materials may include polyethylene, linear low-density polyethylene, high density polyethylene, polypropylene, polycarbonate, thermoplastic polyester elastomer, acrylonitrile butadiene styrene, polyoxymethylene, or the like.

Referring again to FIG. 1, the cushion assembly 46 is installed to a carrier 68 underneath the trim cover 26 with the seat assembly 20 according to an embodiment. This installation may include attaching the suspension wire 58 to a suspension. Alternatively, the installation may attach the tab 58 directly to the carrier 68. In another embodiment, the cushion assembly 46 is installed to a frame 70 and concealed by the trim cover 26 by attachment of the support 58 directly to the frame 70. Regions of the trim cover 26 are partially removed in FIG. 1 to reveal the strands 30 of the cushion assembly 46.

According to a first aspect, an assembly is provided with a unitary mesh of expanded thermoplastic resin strands with a cavity formed therein. A trim component or a support member is oriented at least partially within the cavity. A weld is formed at least partially along the mesh adjacent to the cavity to retain the trim component or the support member within the cavity.

According to a second aspect, the assembly of the first aspect is provided wherein the weld is formed along mating surfaces of the mesh.

According to a third aspect, the assembly of the second aspect is provided wherein the cavity is formed by compressed regions in the mating surfaces of the mesh.

According to a fourth aspect, the assembly of any of the first aspect to the third aspect is provided wherein the trim component or the support member extend through the mesh.

According to a fifth aspect, the assembly of the fourth aspect is provided wherein the weld is formed along a lateral side of the trim component or the support member.

According to a sixth aspect, the assembly of any of the first aspect to the fifth aspect is provided wherein the trim component is oriented partially in the cavity.

According to a seventh aspect, the assembly of the sixth aspect is provided wherein the trim component is further provided with a tab to attach to a structural member.

According to an eighth aspect, the assembly of any of the first aspect to the seventh aspect is provided, wherein the support member is oriented partially in the cavity.

According to a ninth aspect, the assembly of the eighth aspect is provided wherein the support member is further provided with a suspension wire.

According to a tenth aspect, the assembly of any of the first aspect to the ninth aspect is provided, wherein the mesh is welded without adhesive.

According to an eleventh aspect, the assembly of any of the first aspect to the tenth aspect is provided, wherein the weld is further provided as a consistent quantity of strands.

According to a twelfth aspect, a seat cushion assembly is provided as the assembly of any of the first aspect to the eleventh aspect.

According to a thirteenth aspect, a seat assembly is provided with a seat frame, and a cushion assembly according to the twelfth aspect.

According to a fourteenth aspect, a method is provided by orienting a trim component or a structural member between a first region of a mesh of expanded thermoplastic resin strands and a second region of a mesh of expanded thermoplastic resin strands. The first region is welded to the second region.

According to a fifteenth aspect, the method of the fourteenth aspect is provided with compressing the first region of the mesh and the second region of the mesh to form a cavity for the trim component or the structural member.

According to a sixteenth aspect, the method of the fourteenth aspect or the fifteenth aspect is provided with extending a welder to contact the first region or the second region of the mesh to weld the first region and the second region of the mesh.

According to a seventeenth aspect, the method of the sixteenth aspect is provided with retracting the welder after welding the first region and the second region of the mesh.

According to an eighteenth aspect, the method of any of the fourteenth aspect to the seventeenth aspect is provided with ultrasonic welding the first region and the second region of the mesh.

According to a nineteenth aspect, the method of any of the fourteenth aspect to the eighteenth aspect is provided with welding the first region of the mesh to the second region of the mesh of a unitary layer of the mesh.

According to a twentieth aspect, the method of any of the fourteenth aspect to the nineteenth aspect is provided with stacking the first region from a first layer of the mesh and the second region from a second layer of the mesh prior to welding.

According to a twenty-first aspect, the method of any of the fourteenth aspect to the twentieth aspect is provided with welding the first region of the mesh to the second region of the mesh without adhesives.

According to a twenty-second aspect, the method of any of the fourteenth aspect to the twenty-first aspect is provided with varying power, voltage, current, welder extension distance, or weld frequency of a welder to vary a weld.

According to a twenty-third aspect, a cushion is formed by the method of any of the fourteenth aspect to the twenty-second aspect.

According to a twenty-fourth aspect, a seat cushion is formed by the method of any of the fourteenth aspect to the twenty-second aspect.

According to a twenty-fifth aspect, the method of any of the fourteenth aspect to the twenty-second aspect is provided with installing the welded regions of the mesh into a seat assembly. The trim component or the structural member is attached to a seat frame of the seat assembly.

According to a twenty-sixth aspect, a product is formed by a process by orienting a trim component or a structural member between a first region of a mesh of expanded thermoplastic resin strands and a second region of a mesh of expanded thermoplastic resin strands. The first region is welded to the second region.

While various embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. An assembly comprising:
a cushion with an aperture formed at least partially therein, wherein the aperture has a first cross-sectional dimension; and
a trim cord inserted at least partially within the aperture of the cushion, wherein the trim cord has a second cross-sectional dimension that is smaller than the first cross-sectional dimension of the aperture.

2. The assembly of claim 1, wherein the cushion comprises a unitary mesh of expanded thermoplastic resin strands.

3. The assembly of claim 2, wherein the trim cord is not welded to the unitary mesh.

4. The assembly of claim 1, wherein the trim cord is inserted into the aperture of the unitary mesh of expanded thermoplastic resin strands.

5. The assembly of claim 1, wherein the aperture is formed through the cushion.

6. The assembly of claim 1, wherein a plurality of unitary mesh segments is welded.

7. The assembly of claim 6, wherein the plurality of unitary mesh segments is welded without adhesive.

8. The assembly of claim 1, wherein a first segment of expanded thermoplastic resin strands is welded to a second segment of expanded thermoplastic resin strands at least partially over the aperture.

9. The assembly of claim 2, wherein the trim cord is welded to a region of the unitary mesh of expanded thermoplastic resin strands adjacent to the aperture formed in the unitary mesh.

10. The assembly of claim 2, wherein the aperture of the unitary mesh has an inner dimension, and wherein the trim cord has a cross section that is smaller than the inner dimension of the aperture.

11. The assembly of claim 1, wherein the trim cord is comprised of a polyethylene material.

12. A seat cushion assembly comprising: the assembly of claim 1; and a trim cover attached to the trim cord.

13. The seat cushion assembly of claim 12 further comprising:
a seat frame, wherein the cushion is attached to the seat frame; and
a trim cover attached to the trim cord.

14. An assembly comprising:
a unitary mesh of expanded thermoplastic resin strands with an aperture formed therein; and
a trim cord inserted within the aperture of the unitary mesh.

15. The assembly of claim 14, wherein the trim cord is not welded to the unitary mesh.

16. The assembly of claim 14, wherein a plurality of unitary mesh segments is welded.

17. The assembly of claim 16, wherein the plurality of unitary mesh segments is welded without adhesive.

18. The assembly of claim 14, wherein a segment of expanded thermoplastic resin strands is welded to the unitary mesh of expanded thermoplastic resin strands at least partially over the aperture.
